(19) United States
(12) Patent Application Publication
(10) Pub. No.: US 2022/0292047 A1
(43) Pub. Date: Sep. 15, 2022

(54) SYSTEM FOR THE EXCHANGE OF MESSAGES THROUGH AN APPLICATION SOFTWARE

(71) Applicant: Robert Bosch GmbH, Stuttgart (DE)

(72) Inventors: Joshua-Niclas Oergele, Waldenbuch (DE); Christian Kahr, Esslingen (DE); Micha Muenzenmay, Stuttgart (DE); Mouham Tanimou, Goeppingen (DE); Tobias Krug, München (DE); Udo Schulz, Vaihingen/Enz (DE)

(21) Appl. No.: 17/769,887

(22) PCT Filed: Oct. 15, 2020
(86) PCT No.: PCT/EP2020/079077

§ 371 Date: Apr. 18, 2022

(30) Foreign Application Priority Data
Nov. 6, 2019 (DE) 10 2019 217 046.3

(51) Int. Cl. G06F 13/42; H04L 12/40

(52) U.S. Cl. CPC G06F 13/4282; H04L 12/40; H04L 2012/40215; G06F 2213/0002

(57) ABSTRACT

A system for the exchange of messages through an application software. The system includes an abstraction layer for abstracting the messages and an interface library connected to the abstraction layer via a message broker.

### FIELD

The present invention relates to a system for the exchange of messages through an application software.

### BACKGROUND INFORMATION

Methods are available for the distribution or updating of software (SW) via a wireless data interface—sometimes referred to as “over the air” (OTA). Generic methods are applicable both to application software (SOTA) and to embedded system software (firmware, FOTA).

According to the related art, FOTA and SOTA are utilized, for example, to update the electronic control units (ECUs) of networked motor vehicles and agricultural machinery. In doing so, typically a vehicle connectivity gateway (VCG) is used for the telematic connection between the bus system coupling the electronic control units and the Internet (the figurative “Cloud”).

In this way, beyond maintenance and bug fixes, software that is already installed is able to expand the range of functions of in-vehicle electronic control units by features which utilize existing sensors and actuators for new application cases. Corresponding applications may be created by producers or original equipment manufacturers (OEM) of an agricultural machine—perhaps with the aid of a development kit—and offered on a digital marketing platform in the Cloud. For example, advanced telemetry functions or special agricultural functions such as targeted weed control are considered as possible expansions.

German Patent Application No. DE 10 2015 203 766 A1 describes a subsystem for a vehicle having a device-management client, connected via an OTA to a device-management server of the backend, for the exchange of device-, vehicle- and diagnostic-, as well as software update information; a download client, connected via the OTA to a download server of the backend, for downloading a software update from the backend into the vehicle; software-update clients, connected to the download client, for applying the software update; and a vehicle-update client, connected to the download client and the software-update clients, for coordinating the software update.

In the course of independent development, container virtualization or operating-system virtualization, already customary for some time in computing-center operations, is more recently increasingly finding its way into the practice of embedded systems. This method makes it possible to operate multiple instances of an operating system as so-called guests, isolated from one another, on one host system. In this way, the host is able to make available to each application (app) encapsulated within such a container, a complete runtime environment that, for example, may include dynamic libraries of the programming language such as Java, C or Python used by the respective developer. Although this “light-weight” form of the virtualization imposes a few restrictions on the guests compared to the use of a hypervisor, it has the advantage that all containers jointly use the kernel of the native operating system—typically Linux, BSD, Solaris or another Unix-like system. The use of containers thus conserves the scanty resources of embedded systems.

### SUMMARY

The present invention provides a system for the exchange of messages through an application software on an electronic control unit.

A basic feature of the approach according to the present invention is the creation of interfaces which permit an agnostic utilization of interfaces, actuators and sensors external to electronic control units, as well as interfaces such as services internal to electronic control units. Two complementary elements are used for that purpose: a database that has interfaces and is alterable dynamically at runtime (hereinafter: “interface library”) and a type of modifiable adapter (hereinafter: “abstraction layer”), whose components permit a service-oriented and container-based system architecture. In addition, the abstraction layer allows communication via deeper-lying levels.

One advantage of this design approach in accordance with the present invention lies in the possibility revealed of using the SW communication infrastructure underlying the system. In this case, the implementation is not limited to one specific machine, but rather behaves dynamically, thus changes automatically with changing variants of a connected hardware (HW). The developer of an application is supported by the platform in the processing of this potential dynamic with respect to connected hardware—and consequently available application programming interfaces (APIs). In addition, certain variants with respect to process parameters are taken into account by the platform, and therefore are no longer relevant for the application-software developer. For example, this holds true for units of setpoint values or actual values of internal signals and on bus systems.

Advantageous further developments of and improvements to the basic features of the present invention are made possible by the measures disclosed herein. Thus, the abstraction layer may have a programming interface which connects the interface library described to a message broker. By the use of such interfaces and a communication architecture based on layers, the overall system architecture may be designed modularly, that is, may be altered statically and dynamically. For example, the implementation of the communication broker may be replaced without altering the entire architecture. Likewise, for example, a driver module of the interface library may be reloaded at runtime. In this case, the use of the APIs above represents the central interface of the service-oriented software components with their respective advantages.

According to a further aspect of the present invention, the interface library may include adapters for a wide variety of interfaces, which are supported by corresponding drivers of the system. This has the advantage that with the same architecture, nearly all interfaces of application software supported by electronic control units may be abstracted and used agnostically. The latter in turn permits efficient development—independent of electronic control units—of application software with a wide variety of features.

### BRIEF DESCRIPTION OF THE DRAWINGS

Exemplary embodiments of the present invention are explained in greater detail in the following description and represented in the figures.

FIG. 1 shows the block diagram of a system according to one specific example embodiment of the present invention.

FIG. 2 shows schematically an interface library of the system according to FIG. 1.

FIG. 3 shows the connection between the interface library and the application software.

FIGS. 4A and 4B (together) show a model of a seeder.

### DETAILED DESCRIPTION OF EXAMPLE EMBODIMENTS

An embodiment of the present invention includes multiple elements, which shall now be explained in detail. In this context, the different tasks, modes of operation and advantages of the abstraction layer as well as of the interface library are also described. The service-oriented communication or architecture of the system builds on this layer model of the interfaces.

According to the present invention, the abstraction layer and the interface library represent an expansion and improvement of existing layer models for communication: The abstraction layer with its APIs is oriented towards the layers of the conventional OSI model. Its implementation and that of the interface library is independent of the target HW. According to the understanding above, in this case, the individual components are able to be exchanged. Such an exchange requires only that the respective intermediate layers be exchanged correspondingly. For example, the message broker may be exchanged, while the remaining architecture—with the exception of the corresponding API of the abstraction layer—does not have to be changed.

In contrast to the OSI layer model, the communication in this case takes place “based on agreement”, so to speak, in that for each API, the fulfillment of non-functional requirements—for instance, the observance of a certain reaction time—is assured. The interface library has the task of validating this communication, since it requires the inclusion of computer-oriented aspects, e.g., with respect to ISOBUS or input/output (I/O).

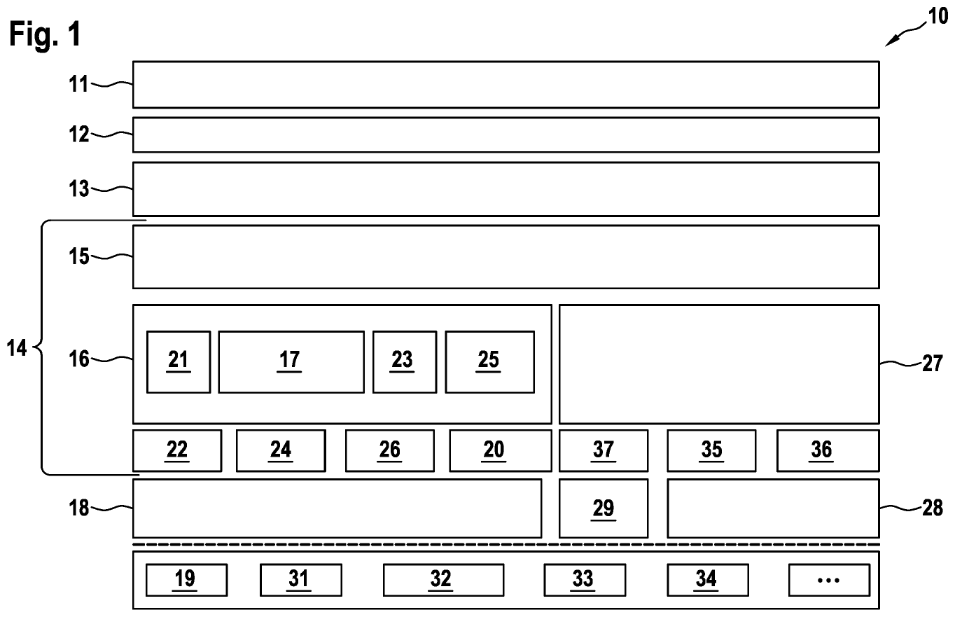

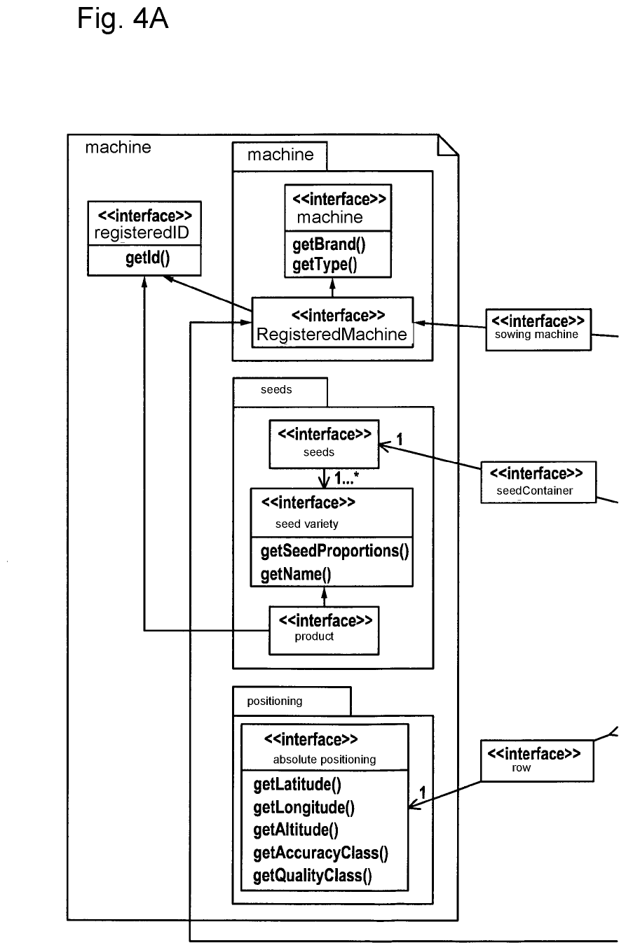

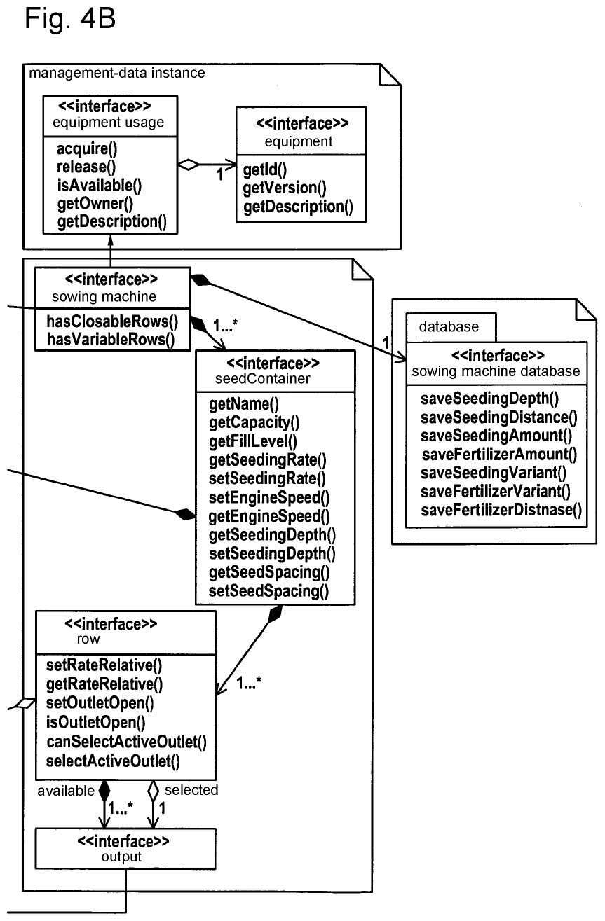

In this context, abstraction layer (12) and interface library (14) represent layers of system (10), which for their part are made up of layers (see FIG. 1). The central element of interface library (14) in this case is a coordinator (15), which—beyond ISOBUS, e.g., in the case of machines with proprietary interfaces—connects concrete instances of generic machine models (see, e.g., FIG. 4 for the seeder model) via adapter modules (16 and 27) to I/O modules and other peripheral devices.

FIGS. 4A and 4B (together) show by way of example the software machine model of a seeder. The block “sowing machine” describes the generic functions of a seeder (outlet, rows, tank, seeder). The block “machine” describes the management data or operating data of the specific seeder (machine, seed, position). The block “management-data instance” is the instance of the management data or operating data and the generic functions. The instantiation is carried out by abstraction layer (12), and interface library (14) uses it. In addition, the management data or operating data are stored in the “database” (e.g., in the Cloud).

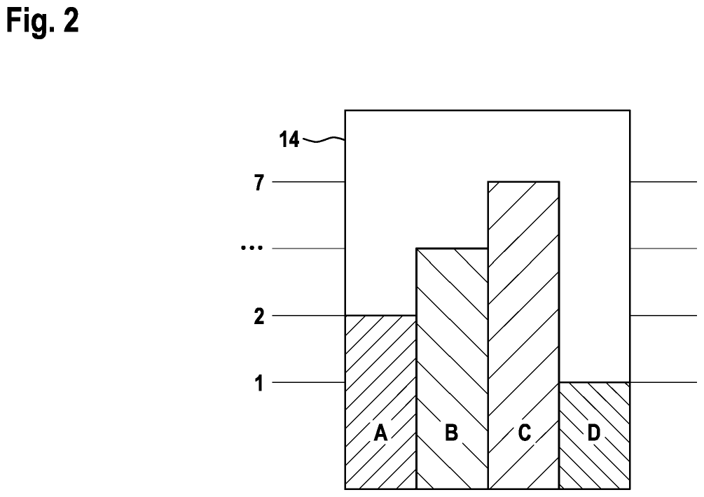

For example, these modules may be different in terms of the programming languages used or their syntactic depth. For this reason, interface library (14) provides equivalents to various interfaces of the OSI model, which reflect its different levels (1-7) (see FIG. 2).

In this context, components A to D shown in FIG. 2 represent, by way of example, different implementation depths corresponding to the levels of the OSI model. In this case, interface library (14) supplements the “missing” layers up to the service levels (level 7), in order to be able to offer abstraction layer (12) a generic interface. As shown, different implementation levels are supported. This is necessary, since peripheral devices of different manufacturers/type support different levels. For example, component A could correspond to the GPS driver in FIG. 1, component B could correspond to the socketCAN, component C could correspond to the ISOBUS and component D could correspond to an arbitrary I/O (e.g., temperature sensor).

All elements (21, 17, 23, 25) located in interface-library ISOBUS adapter (16) are likewise adapters. Interface-library basic-parts adapter (17) contains all interfaces that are mutual for all available ISOBUS stacks (22, 24, 26). The other adapters (21, 23, 25) are exemplary adapters for supplier-specific parts of the ISOBUS stack, which the suppliers bring along with them, for example. All adapters utilize a specifically created machine model to define the interface space of these adapters.

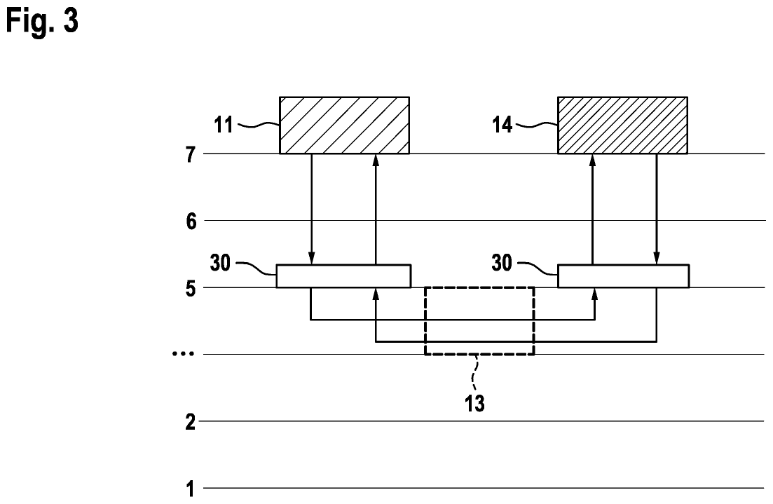

Comparable considerations underlie abstraction layer (12) (see FIG. 3). It permits the language-agnostic exchange of information between application programs (11) without platform dependencies, thus, for example, regardless of the implementation and performance of message broker (13) utilized. In addition, it is dynamically configurable and, in particular, allows expansion by new executable units or reconfiguration of an existing executable unit. Finally, it permits the monitoring and control of communication, e.g., with respect to the bandwidth demanded.

This is made possible on the part of application software (11) by an API, which conceals all the indicated implementation details from the developer. The connection to message broker (13) is accomplished with the aid of a further programming interface (30) of abstraction layer (12). Interface library (14) is also connected to message broker (13) via a corresponding programming interface (30).

A further characteristic of the present specific embodiment is the dynamic scalability of its interfaces. In this connection, their object-oriented modeling permits the adaptation to various machine sizes. For example, the machine models are scalable in this way: In the case of an agricultural sprayer, for instance, with respect to the working width and number of nozzles, in the case of a seed drill, with respect to the number of rows. To that end, the software platform defines abstract classes, from which concrete machine types are derived by implementation of the inherited access methods and definition of variables. At the same time, the object-oriented modeling supports a corresponding granularity in terms of the scope of performance of hardware and application software (11).

This detailed accuracy shall now be explained on the basis of an agricultural sprayer with section control. The machine model provides classes for sprayer, tank and section, where a sprayer may include multiple tanks, which on their part, might have multiple sections. In this case, the class “sprayer” defines methods for access to its attributes by the class type “tank”; the latter in turn defines methods for access to its attributes by the class type “section”. Finally, this class defines methods for opening and closing the nozzles. The object hierarchy described enables the modeled machine to respond to different levels with different granularity.

In this way, interface library (14) lends to system (10) of the present invention, a high degree of compatibility with a wide variety of machines. For instance, if application software (11) supports only the control of one section of an agricultural sprayer, but the latter has four differently controllable sections, interface library (14) allows the control of all sections. A dynamic adaptation at runtime is also possible: For example, if interface library (14) determines that new or more detailed machine interfaces are available on an add-on unit, a service-advertising mechanism sees to it that message broker (13) knows of the availability of these machine interfaces and the relevant drivers (28) are downloaded from the Cloud. Application software (11) is able to find and utilize the new interfaces via a discovery mechanism.

The runtime behavior opens up new possible uses for an electronic control unit according to the present invention. To that end, in a manifest data file, each application software (11) places certain minimum demands on the interfaces and resources of the machine controlled by it, which are stored in a central registry during the installation process of the container in question. However, so long as no corresponding machines are connected or are controlled at runtime, these interfaces remain abstract.

After the installation process, application software (11) and interface library (14) are connected for each individual API through an arbitration process. This combination ensures efficient management of the APIs. When the figurative “handshake” is complete, interface library (14) then adapts itself to application software (11), that is, concretizes the interfaces in accordance with pertaining notes in the registry. After that, a protocol which permits the meta-communication, but not the exchange of useful data, between application software (11) and interface library (14) is agreed upon. This meta-communication is used for the exchange of information which does not pertain directly to the control of actuators, drivers, etc., but rather their functional performance and quality of service (QoS).

After running through these steps, advertising, discovery, arbitration and monitoring of APIs and access to them are agreed upon, and afford application software (11) a communication that is reliable in terms of function, avoidance of bit errors, data integrity and data consistency.

The testability of application software (11) is also increased by the communication architecture above. Thus, for example, for the purpose of component tests, interface library (14) may be replaced by a mockup. To that end, a virtual machine class simulates a physical machine. In the extreme case, the entire application software (11) for a machine model may be developed and especially tested, without its developer having at its disposal a sample or even detailed knowledge of this machine.

1-11. (canceled)

12. A system for an exchange of messages through an application software, comprising:
an abstraction layer configured to abstract the messages; and
an interface library connected to the abstraction layer via a message broker.

13. The system as recited in claim 12, wherein:
the abstraction layer has a programming interface; and
the interface library is connected to the message broker via the programming interface.

14. The system as recited in claim 12, wherein:
the system includes a driver layer for a physical layer; and
the interface library includes a coordinator for coordination of hardware components, an ISOBUS adapter having a basic part, and at least one CAN protocol stack.

15. The system as recited in claim 14, wherein:
the coordinator is adapted to an interface-library basic-parts adapter of the ISOBUS adapter;
the interface-library basic-parts adapter contains mutual interfaces for other supplier-specific adapters; and
the interface library includes protocol stacks for accessing the physical layer using the driver layer.

16. The system as recited in claim 14, wherein:
the coordinator is adapted to supplier-specific adapters of the ISOBUS adapter;
the supplier-specific adapters contain supplier-specific interfaces; and
the interface library includes protocol stacks for accessing the physical layer using the driver layer.

17. The system as recited in claim 14, wherein:
the coordinator is adapted to an adapter for further interfaces;
the adapter includes further service-oriented adapters;
the interface library includes manufacturer-nonspecific and service-nonspecific protocol stacks; and
the protocol stacks communicate with the physical layer using drivers.

18. The system as recited in claim 14, wherein:
the coordinator is adapted to an adapter for further interfaces;
the adapter includes further service-oriented adapters;
the interface library includes manufacturer-specific and service-specific protocol stacks; and
the protocol stacks communicate with the physical layer using drivers.

19. The system as recited in claim 12, wherein:
the interface library includes a further adapter for other interfaces; and
the system includes further drivers for the interfaces.

20. The system as recited in claim 19, wherein the interfaces include at least one of the following:
a LIN bus, or
a FlexRay bus, or
an Ethernet, or
further inputs and outputs.

21. The system as recited in claim 12, wherein:
the interface library includes a GPS service; and
the system includes a GPS driver.

22. The system as recited in claim 12, wherein:
the interface library includes a sensor service, or
the interface library includes an actuator service.
